(19) United States
(12) Patent Application Publication
(10) Pub. No.: US 2011/0137700 A1
(43) Pub. Date: Jun. 9, 2011

(54) METHOD AND APPARATUS FOR SCHEDULE MANAGEMENT INCLUDING SHARED RESPONSIBILITIES

(75) Inventor: Matti Hämäläinen, Lempaala (FI)

(73) Assignee: Nokia Corporation, Espoo (FI)

(21) Appl. No.: 12/631,462

(22) Filed: Dec. 4, 2009

(51) Int. Cl. G06Q 10/00; G06F 15/177

(52) U.S. Cl. 705/7.18; 709/221

(57) ABSTRACT

A method is provided for creating a calendar event whose responsibility is shared among a plurality of responsible parties, assigning the calendar event to a subset of the plurality of responsible parties, updating the calendars of each of the subset of the plurality of responsible parties with the calendar event, and resolving any conflicts that the subset of the plurality of responsible parties may have with the calendar event by reassigning the calendar event to a second subset of the plurality of responsible parties. The assigning of the calendar event may also include a fairness assessment that evaluates the previously completed calendar events and the scheduled future calendar events for the subset of the plurality of responsible parties.

### TECHNOLOGICAL FIELD

Example embodiments of the present invention relate generally to computer implemented schedule management and, in particular, to sharing responsibilities and allocating calendar events within a shared schedule.

### BACKGROUND

Traditional schedule management of hand-writing events and tasks on paper calendars has been all but replaced by ubiquitous computer-based calendars that allow scheduling of events through manual entry, electronic invitations, and meeting requests. Such events can be added to an individual's or a group's calendar in such a manner to allow or prevent the overlapping of events or avoiding conflicts.

Often a calendar event may be scheduled wherein there are conflicts and a user must choose to both accept the calendar event and resolve the conflict themselves, or decline the calendar event and risk the event going unattended.

Calendar events that require the acceptance of a large number of people are often very difficult to schedule due to the incongruities between the schedules of individuals. Presently available scheduling systems may look out into the future to determine the first time when all attendees are available, but often that date is too far off and it is impractical to delay the calendar event for that long. Further, analyzing each individual's schedule to determine when it is best to schedule an event may prove tedious.

### BRIEF SUMMARY

In general, example embodiments of the present invention provide an improvement by, among other things, providing a method of scheduling shared calendar events among a plurality of users. In particular, the method of example embodiments provide for creation of a calendar event with a plurality of responsible parties. The method may also include assigning the calendar event to a subset of the plurality of responsible parties. The method may further include updating the calendars of each of the subset of the plurality of responsible parties with the calendar event, determining if there are any conflicts with the calendar event for any of the subset of the plurality of responsible parties, and resolving those conflicts by reassigning the calendar event to a second subset of the plurality of responsible parties.

The assigning of the calendar event may further include assessing the fairness of the assignment which may be evaluated by applying rules associated with a contribution policy to the calendar events previously completed by the subset of the plurality of responsible parties and the future calendar events assigned to the subset of the plurality of responsible parties. A biasing factor may also be included in assessing the fairness that is determined by the ability of the subset of the plurality of responsible parties to complete the calendar event. Rules may be associated with the calendar event such that the assigning of the calendar event to a subset of the plurality of responsible parties includes evaluating the plurality of responsible parties with respect to the rules associated with the calendar event. The method may also include assessing the future calendar events assigned to the subset of the plurality of responsible parties and reassigning the future calendar events. Unresolved conflicts may be reported to a manager or individual responsible for the conflict resolution. The calendar events may also be assigned to a resource.

According to another embodiment of the invention, an electronic device is disclosed to provide for creating a calendar event with a plurality of responsible parties. The electronic device may assign the calendar event to a subset of the plurality of responsible parties. The electronic device may further update the calendars of each of the subset of the plurality of responsible parties with the calendar event, determining if there are any conflicts with the calendar event for any of the subset of the plurality of responsible parties, and resolving those conflicts by reassigning the calendar event to a second subset of the plurality of responsible parties.

The assigning of the calendar event may further include assessing the fairness of the assignment which may be evaluated by applying rules associated with a contribution policy to the calendar events previously completed by the subset of the plurality of responsible parties and the future calendar events assigned to the subset of the plurality of responsible parties. A biasing factor may also be included in assessing the fairness that is determined by the ability of the subset of the plurality of responsible parties to complete the calendar event. Rules may be associated with the calendar event such that the assigning of the calendar event to a subset of the plurality of responsible parties includes evaluating the plurality of responsible parties with respect to the rules associated with the calendar event. The electronic device may also assess the future calendar events assigned to the subset of the plurality of responsible parties and reassigning the future calendar events. Unresolved conflicts may be reported to a manager or individual responsible for the conflict resolution. The calendar events may also be assigned to a resource.

The visualization of a shared responsibility event may be adjusted to support individual needs. When person has a shared responsibility event that is not currently active (assigned to a different person), the event may be visualized as an idle event or it can be hidden from the user according to user preferences or event description (parameterization).

According to yet another embodiment of the present invention, a computer program product comprising at least one computer-readable storage medium having computer-readable program instructions stored therein with the computer-readable program instructions being configured to cause an apparatus to at least provide for creation of a calendar event with a plurality of responsible parties. The apparatus may also be caused to assign the calendar event to a subset of the plurality of responsible parties. The apparatus may further be caused to update the calendars of each of the subset of the plurality of responsible parties with the calendar event, determine if there are any conflicts with the calendar event for any of the subset of the plurality of responsible parties, and resolve those conflicts by reassigning the calendar event to a second subset of the plurality of responsible parties.

According to yet another embodiment the shared responsibility event description contains a state variable, which describes how easily the responsibility can be handed over to other responsible parties hereafter called reschedulability parameters. This parameter can be checked by the calendar software agent that is negotiating new events. Based on the reschedulability parameters, the negotiation agent may assess how difficult it would be to assign the shared responsibility time or resource to the person. If other responsible persons are available or if there in an alternative resource available, the assignment of the event can be done more easily compared to the situation where other parties have already conflicting schedules. Reschedulability parameters provide the necessary information for aforementioned negotiation agents to perform schedule optimization without visibility to the calendar data of other responsible parties. (NOTE this may need another flow chart)

The assigning of the calendar event may further include assessing the fairness of the assignment which may be evaluated by applying rules associated with a contribution policy to the calendar events previously completed by the subset of the plurality of responsible parties and the future calendar events assigned to the subset of the plurality of responsible parties. A biasing factor may also be included in assessing the fairness that is determined by the ability of the subset of the plurality of responsible parties to complete the calendar event. Rules may be associated with the calendar event such that the assigning of the calendar event to a subset of the plurality of responsible parties includes evaluating the plurality of responsible parties with respect to the rules associated with the calendar event. The computer program product may further cause the apparatus to assess the future calendar events assigned to the subset of the plurality of responsible parties and reassign the future calendar events. Unresolved conflicts may be reported to a manager or individual responsible for the conflict resolution. The calendar events may also be assigned to a resource.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a system for employing a calendar application according to one embodiment of the present invention;

FIG. 2 is a schematic block diagram of a mobile terminal according to one embodiment to the present invention;

FIG. 3 is a flow chart of the operations performed in accordance with one embodiment to the present invention;

FIG. 4 is a flow chart of the operations performed in accordance with another embodiment to the present invention;

FIG. 5 illustrates an example embodiment of a calendar application as viewed on the display of a mobile device;

FIG. 6 illustrates another example embodiment of a calendar application as viewed on the display of a mobile device;

FIG. 7 illustrates an example embodiment of a calendar view of a calendar application in accordance with an example embodiment of the present invention;

FIG. 8 illustrates another example embodiment of a calendar view of a calendar application in accordance with another example embodiment of the present invention; and

FIG. 9 is a flow chart of the operations performed in accordance with another embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

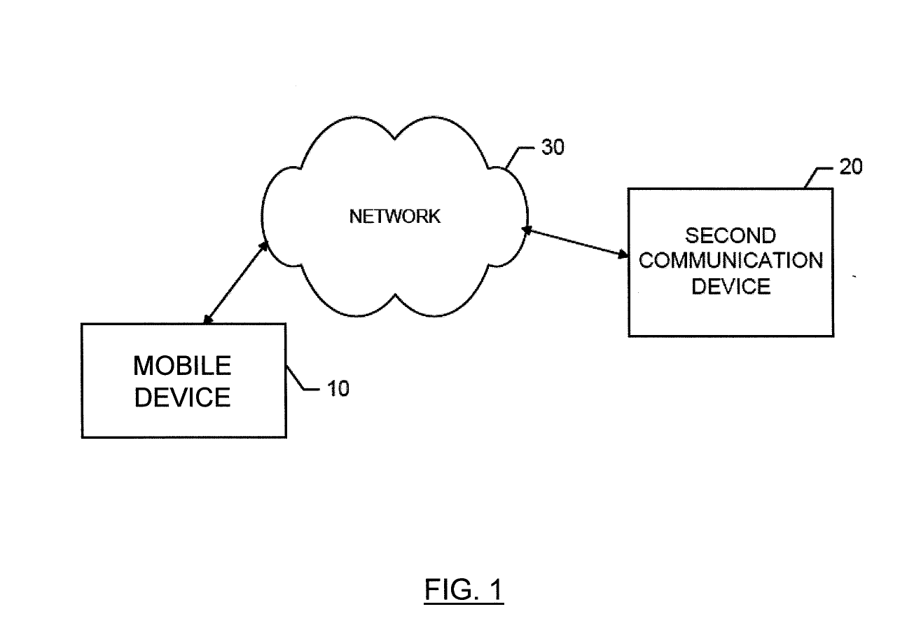

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and the second communication device 20 via the network 30. By directly or indirectly connecting the mobile terminal 10 and the second communication device 20 and other devices to the network 30, the mobile terminal 10 and the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, either of the first communication device and the second communication device 20 may be mobile or fixed communication devices. Thus, for example, the mobile terminal 10 and the second communication device 20 could be, or be substituted by, any of personal computers (PCs), personal digital assistants (PDAs), wireless telephones, desktop computers, laptop computers, mobile computers, cameras, video recorders, audio/video players, positioning devices, game devices, television devices, radio devices, or various other like devices or combinations thereof.

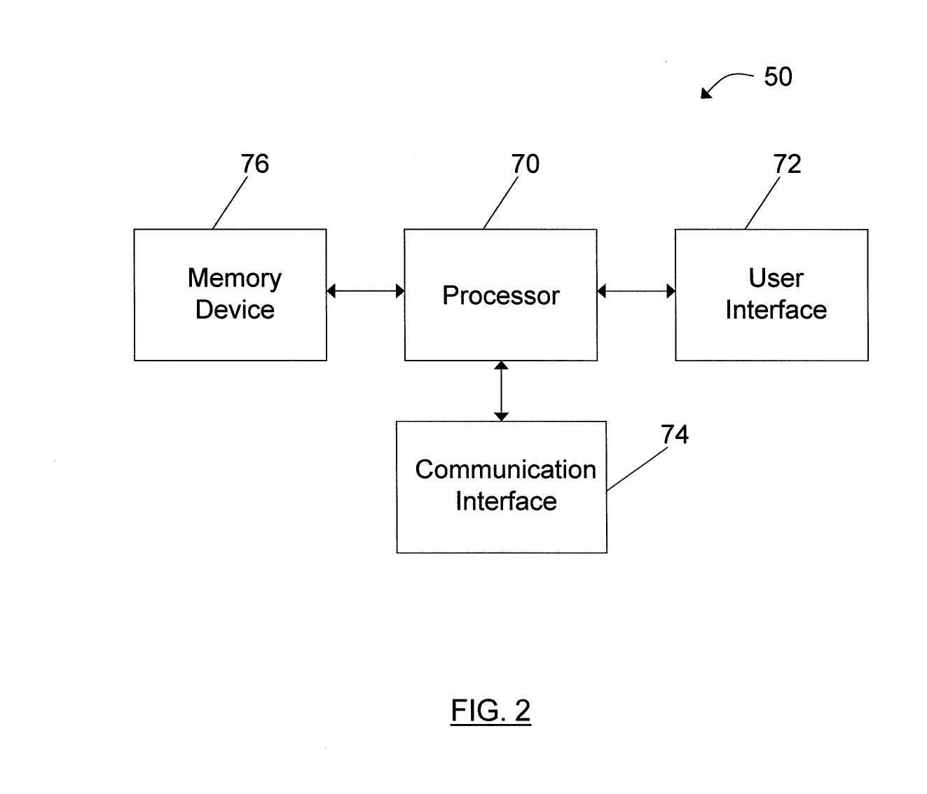

FIG. 2 illustrates a schematic block diagram of an apparatus for facilitating a calendar application according to an example embodiment of the present invention. The apparatus 50 of FIG. 2 may be employed, for example, on or as a communication device (e.g., the mobile terminal 10 and/or the second communication device 20) or a variety of other devices both mobile and fixed (such as, for example, any of the devices listed above). Alternatively, embodiments may be employed on a combination of devices. Accordingly, some embodiments of the present invention may be embodied wholly at a single device (e.g., the mobile terminal 10) or by devices in a client/server or distributed computing relationship. Furthermore, it should be noted that the devices or elements described below may not be mandatory and thus some may be omitted in certain embodiments.

As shown, the apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as processing circuitry, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications via Bluetooth signaling protocol or with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

Referring now to FIG. 1, the system of one embodiment may be configured to support a calendar application that includes calendar events that may have multiple owners belonging to a variety of groups as will be further defined below. More particularly, a calendar application may belong to a single user (or a group of users represented as a single entity), however, the calendar application may work in concert with multiple user's or group's calendar applications. Thus, a user's calendar application may contain information relevant only to that particular user while information is exchanged between the user's calendar application and the groups with which that user is affiliated. An individual's user device may include all calendar events related to that individual's own calendar; however, the user may be able to access other user's calendars. A device may also be used by more than one individual whereupon calendars for each user may be stored or accessed by a single device.

A group, as defined herein, may be a plurality of users that are related by virtue of a common association. A group may include the employees of a particular company, members of a particular family, or members of a common interest group, such as an alumni club. Further, these groups may include groups as defined in social networking sites such as a group of friends on a social networking site or fans of a particular sports team. A user may be able to associate and disassociate themselves with various groups commensurate with the desired participation level with each group's scheduled events.

Additionally, a user, as a member of a group, may also have relevant capabilities or limitations associated with the user. An example of associated capabilities or limitations within a group may include a group that are employees of a company, and associated capabilities or limitations may include “licensed to drive” or “certified electrician” or “requires wheelchair access.” The function of these relevant capabilities or limitations will become apparent with the disclosure below.

Resources may also be available to be scheduled within certain groups. For example, a Family group may include a Mother, a Father, a Daughter, and a Son as the users, while resources may include a van and a compact car. These resources may be scheduled within their associated group (or groups) as will be further disclosed.

A calendar application may include a calendar event for a group. The group may include multiple (M) individuals or users. If the execution of the event requires N contributors to participate in the event, the calendar application ensures that at least N members of the group of M users (M>N) will be assigned to the event. Such an embodiment may include a group that is 20 construction workers employed by a particular contractor. If an event, for example a job that involves painting a large house, requires 6 participants, then 6 of the group of 20 will be assigned to that event by virtue of scheduling the event on each individual user's calendar within the calendar application. In the instant example, N is a subset of M. While the event may only be scheduled for N members of the group M, the event may be visible to all members of M. The event being visible to all members of M may be beneficial as the group may be made more aware of the schedules of other members of their group.

Another example embodiment of how a calendar application according to the present invention may be used is when a meeting is scheduled that requires representatives from a number of groups, such as, for example a vehicle design meeting that requires representatives from the interior, exterior, engine, and transmission groups among others. The calendar event may be assigned to at least one member from each group, and if a member of one group has a conflict, the calendar event may be reassigned to another individual representing that group. The event description may include a hierarchy for different groups with a mixture of required and optional participants or required participants from multiple categories. For example, an event with at least N₁ required participants and at least N₂ least optional participants.

Depending on the authority level of an individual, they may be able to accept or decline a scheduled event. In the case of a group of employees, the employees may not be permitted to decline an event when it is scheduled during normal work hours. If an employee needs to decline such an event, they may be required to consult with a manager that has the authority to decline the event for that individual whereupon another individual from the group would be scheduled to replace the individual that had to decline.

A contribution level may factor in to the scheduling or allocation of an event to an individual user's calendar application. For example, in a group of 20 construction workers, perhaps 15 have been scheduled to work more than 40 hours of combined events in the last week, while 5 have been scheduled to work less than 40 hours of combined events. In the interest of load balancing, the calendar application for the group of 20 construction workers may prioritize the 5 who have worked less than 40 hours such that they receive the next allocation of an event. However, this prioritization may be changed by an override by a manager for other considerations, or the associated capabilities or limitations of the prioritized workers may not coincide with requirements for the next task or event, thus taking priority over the load balancing. The load balancing may be governed by a contribution policy that influences the allocation of the next allocation of a task or event. The contribution policy may contain rules that pertain to how tasks or events are to be distributed and what extenuating factors may influence the prioritization, such as the associated capabilities or limitations of an individual user.

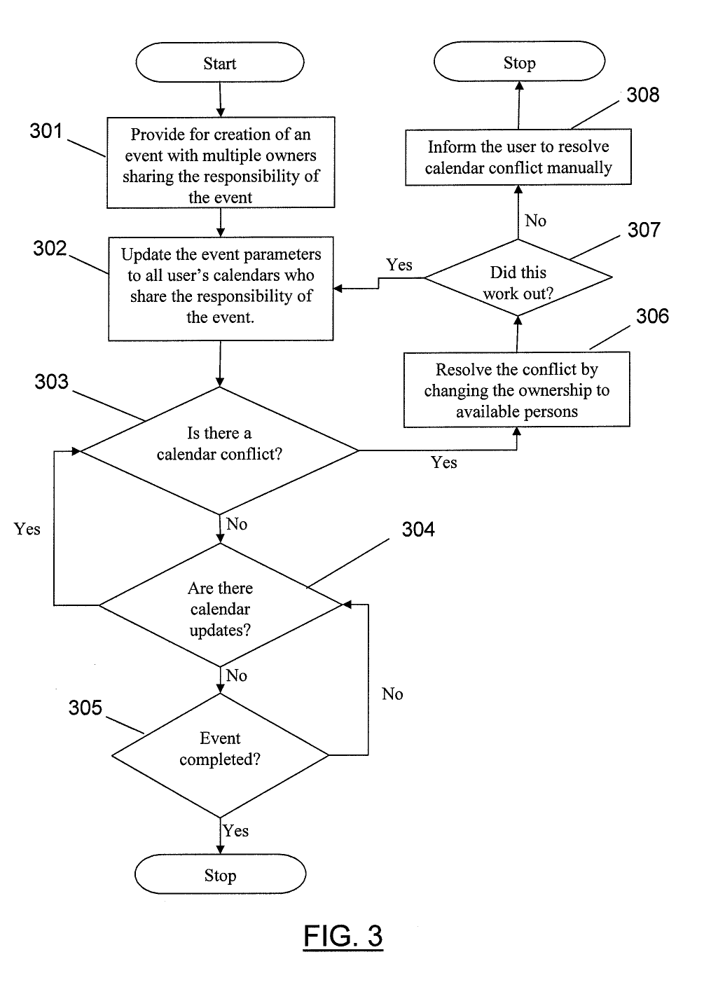

FIG. 3 is a flowchart of an example embodiment of an allocation of event responsibilities of a calendar application between people having shared responsibilities in a group. An event is created at block 301 with multiple owners sharing the responsibility of the event. The event parameters are sent to the user calendar applications of all users who share the responsibility of the event at block 302. The calendar application then determines if there is a conflict with any of the users who share the responsibility of the event at block 303. If there are conflicts, the conflicts are resolved at block 306 by changing the allocated individuals to those that are available. An evaluation is then performed at block 307 to determine if proper allocation was able to be performed. If not, the user, typically the user that created the event, may be notified that manual resolution of the conflict may be necessary at block 308. If the proper allocation is achieved at block 307, the calendar applications of each user that shares the responsibility of the event are updated at block 302. A further evaluation of whether a calendar conflict exists occurs at block 303. If no conflicts exist, any further calendar application updates are determined at block 304. If there are no calendar application updates, the method then determines if the event is completed at block 305. If the event is not completed, calendar updates may be required at block 304 to extend the time allotted for the event whereupon conflicts are re-evaluated at block 303. This occurs until the event is completed whereupon the method is complete.

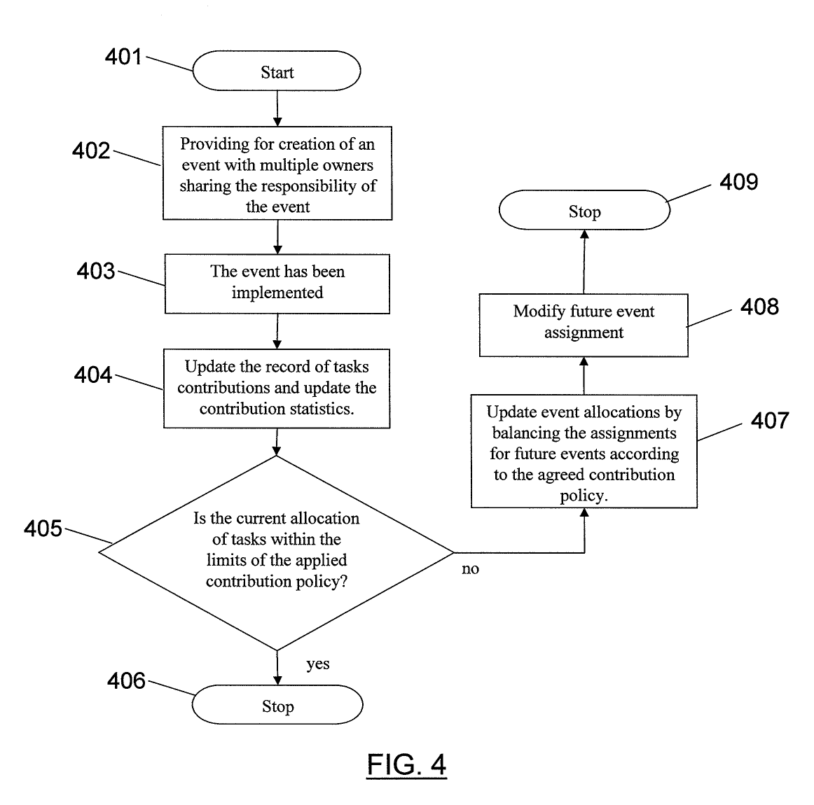

FIG. 4 is a flowchart of an example embodiment of an event sharing policy that can be implemented to include fairness or equality in the event allocation system of a calendar application within a group that has shared responsibilities, for example a Mother and Father may have the shared responsibility of picking up a child from school. A calendar event may be created with multiple owners sharing the responsibility at block 402. At block 403 the event may be implemented in the calendar application of the group of responsible parties. At block 404, the record of events, both completed in the past and those that are allocated in the future, are compared for the members of the group of responsible parties for application of the contribution policy rules. At block 405, the contribution policy rules are applied and the event is allocated to a user within the group of responsible parties. If, upon allocation, the contribution policy rules are met and the future events fall within the limits of the contribution policy, the allocation of the event responsibilities ends at block 406. If the allocation of the event responsibility causes the current allocation of events to fall outside of the limits of the contribution policy, the events are updated by re-assigning future events to balance the load according to the agreed contribution policy at block 407. The updated, altered events are modified on the calendar application of each individual user affected by the updated event allocations at block 408 and the allocation of event responsibilities ends at block 409. While the method of FIG. 4 is disclosed with respect to allocating events to individual users, a similar method may be used to assign a number of users to an event or task or to assign resources in the same load-balancing manner. The assignment of resources may be included as a subroutine that is initiated once the event has been allocated to a user between blocks 405 and 406, or between 408 and 409.

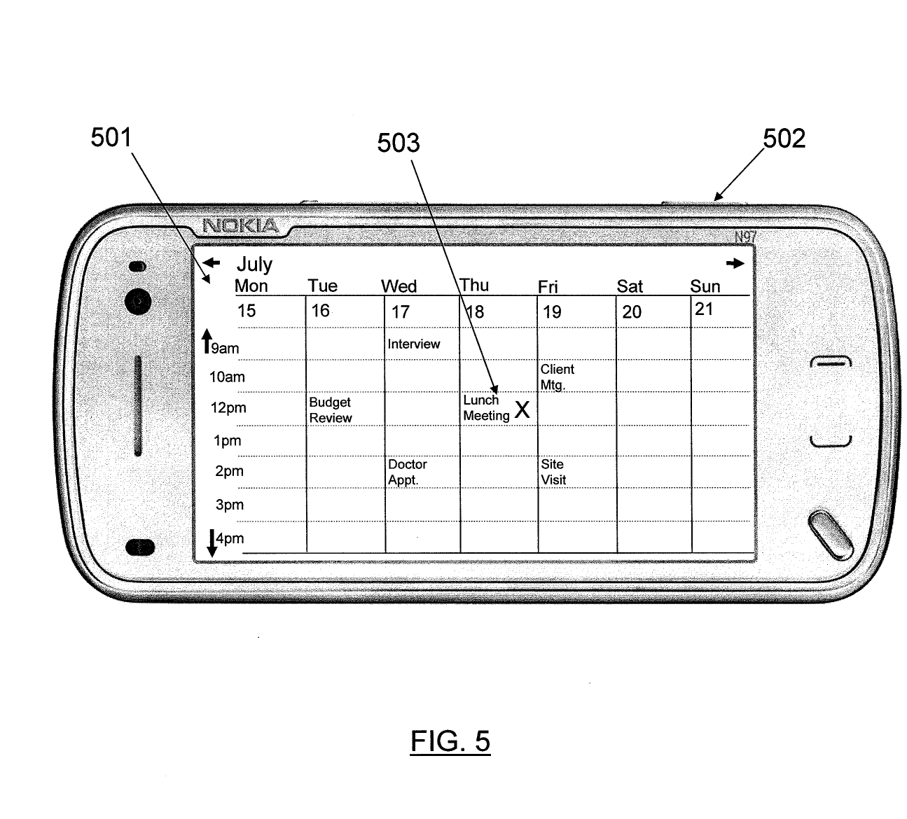

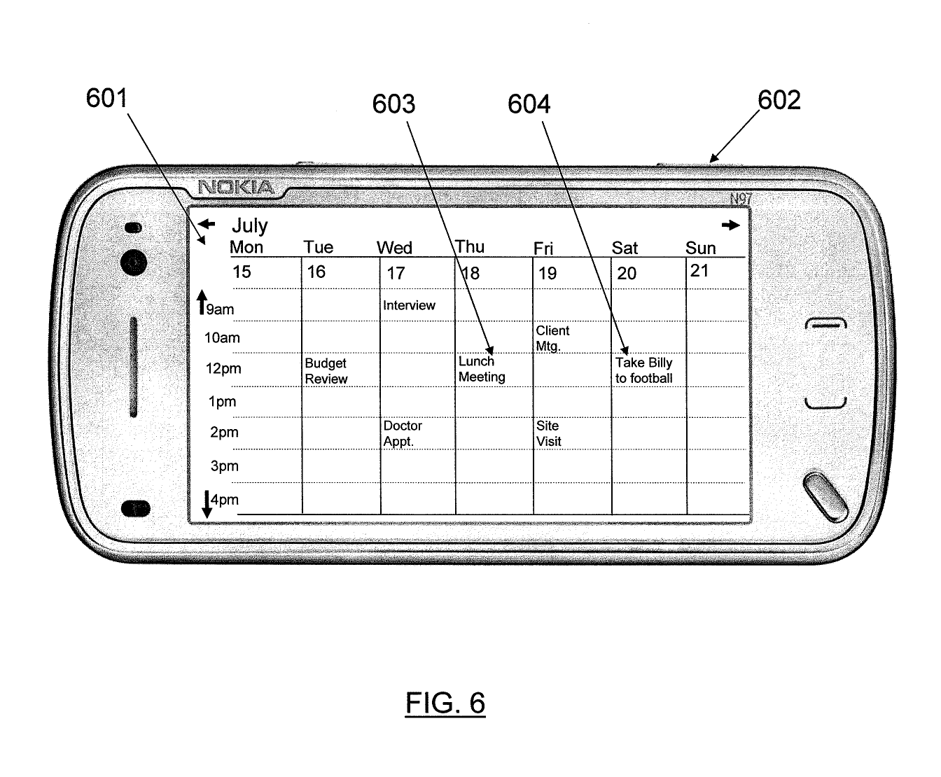

FIGS. 5 and 6 illustrate an example scenario of an example embodiment of the present invention, wherein two parents have a shared responsibility for picking up their child from school. In the example embodiment, the first parent has been assigned the task of picking up the child from school on Thursday, July 18 at noon, possibly by virtue of the fairness assessment using the contribution policy rules. FIG. 5 is an illustration of an example embodiment of a calendar view of a calendar application on the display 501 of the first parent's mobile device 502. The calendar application may display the events of the user in a grid format. As illustrated at 503, an “X” appears in the calendar entry beside the “Lunch Meeting” event which represents the conflict with the shared event of picking up the child from school which occurs at the same time. The responsibility for the event of picking up the child from school may be reallocated to the second parent through the method illustrated in FIG. 4. Subsequently, the X on the first parent's calendar displayed on the device disappears as shown at 603 in FIG. 6. As noted above with respect to the method of FIG. 4, upon reallocation of an event, a re-distribution or load-balancing may occur as a result of the fairness assessment through application of the contribution policy rules. As such, in the example of FIG. 6, the shared responsibility event of “Take Billy to Football” has been removed from the second parent's calendar (not shown) and added to the first parent's calendar to more evenly distribute the task allocation in a fair manner.

The system may notify the change of responsibility according to event or user preferences (settings of the calendar application) according to the multimodal notification methods known in the prior art.

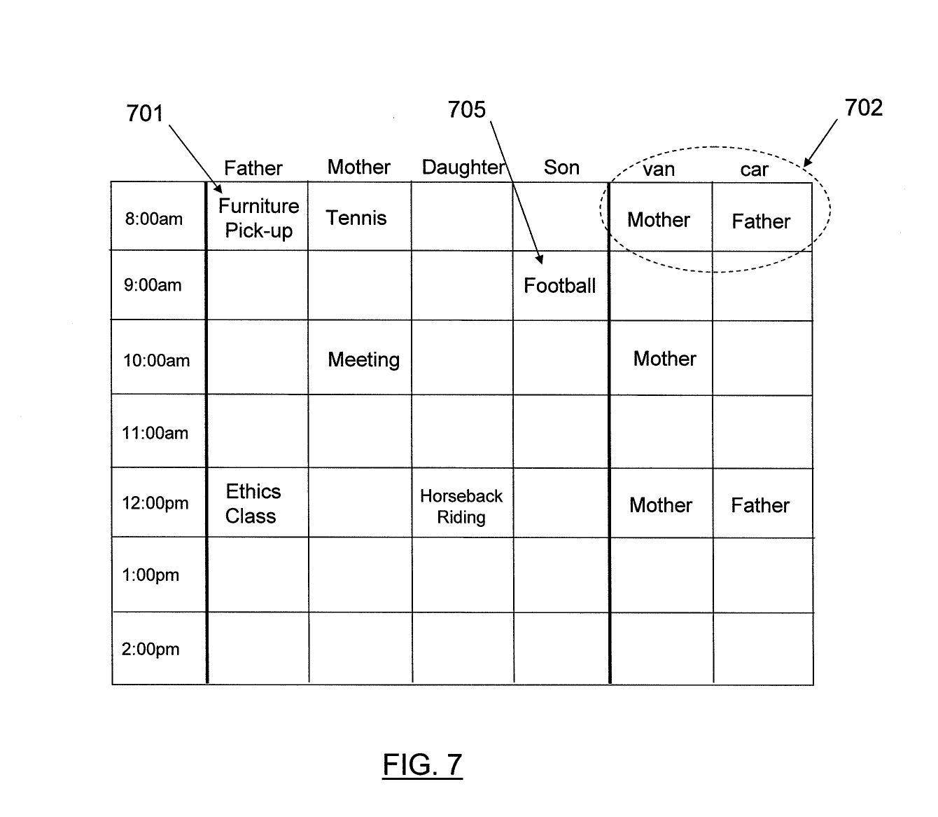

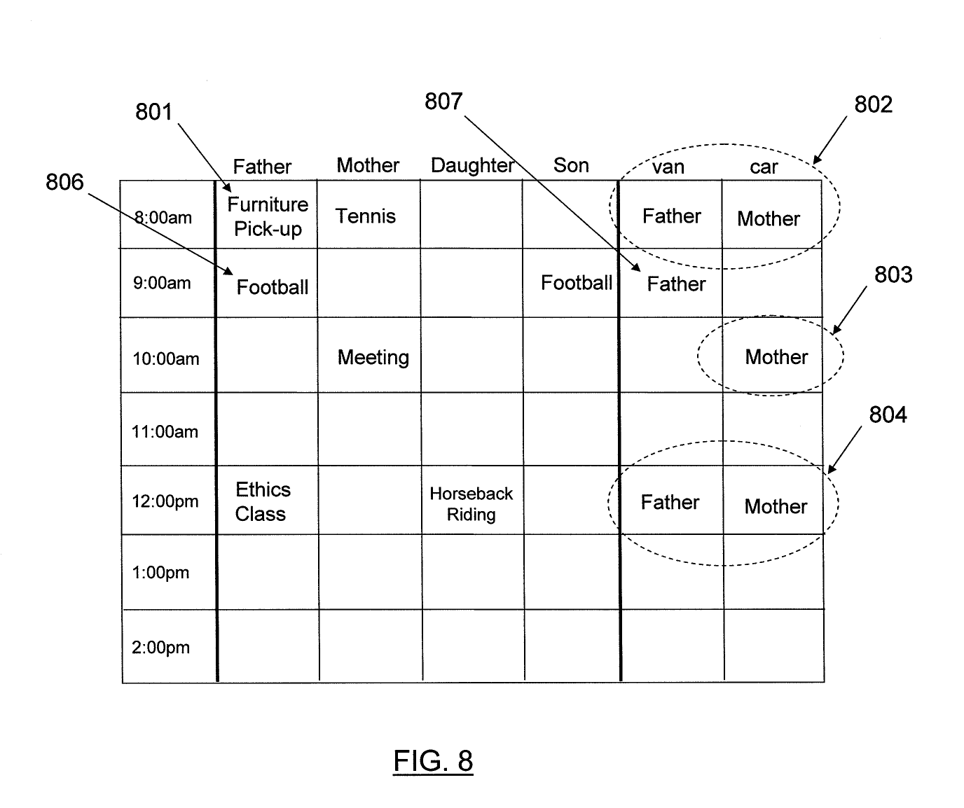

FIG. 7 is an illustration of an example embodiment of a calendar application for the Family group described above that includes the Mother, Father, Daughter, and Son as individual users and the van and compact-car as resources of the group. The calendar of FIG. 7 may be embodied on a display of a user device. The associated capabilities or limitations of the users in this group may include that Mother and Father are each licensed drivers, while Daughter and Son are not. Further, capabilities or limitations may be applied to the resources too such as the van, capable of carrying up to 7 passengers or carrying larger loads, while the compact car is capable of carrying up to 4 passengers and only small loads. Thus, in the example embodiment of FIG. 7, a scheduling conflict exists when the Father is allocated the event of 701 in his individual user calendar application. As can be seen at 702, the Mother has previously been assigned the van resource leaving the compact car resource for the Father, which is not conducive to the newly scheduled task 701 of “Furniture Pick-up.” When an event is scheduled, details or limitations may be applied to the event to ensure resources or people are properly allocated. In the instant example of picking up furniture, the limitation may be added to the task of “large load capacity needed.” Similarly, if the task were to pick up the football team, the limitation of “large passenger capacity needed” could be added to the task. As a large load capacity is needed for the task 701, the Father should be allocated the appropriate resource if available. Since Mother is playing tennis at the time, her event does not require a resource with a large load capacity or large passenger capacity. Thus, as can be seen in FIG. 8, after the method of allocating event responsibilities and resource requirements, the van has been allocated to Father while the car has been allocated to Mother at 802. As the Mother has further resource needs at 10 am and 12 pm, the allocation method may further evaluate the resource requirements and determine that it is acceptable to allocate the car to the mother at 10 am and 12 pm (803 and 804) to avoid having to switch resources during the day, which may lead to confusion and delay. The example embodiment illustrated in FIGS. 7 and 8 shows the schedules of each member of the group or family. The ability to view the schedules and events of other members of the group may be beneficial to the group. For example, if Father wanted to run an errand after one of his scheduled events, he may reference the calendar of FIG. 7 or 8 to verify that his errand will not conflict with another family member's scheduled event. Further, the schedules of other members of the group, or events that other members have scheduled, may be a selectable feature such that a user can turn on, or show other group member's events or hide them, for example to avoid a cluttered appearance.

Referring again to FIG. 7, the Son is scheduled to have Football practice at 9:00 am. A requirement associated with this event may be 1) a person who is a licensed driver and 2) a vehicle for that licensed driver. Thus, in FIG. 8, the Father is allocated to the Football event at 9:00 am (806) and the van is allocated as the resource 807. While it is noted that the above referenced flowchart of FIG. 4 allocates events and tasks to people having shared responsibilities including a fairness assessment, an event may carry a biasing weight. For example, the Furniture Pick-up task may be possible for the Mother to complete, but it may be preferred that the Father complete the task. Therefore, if scheduling permits, the Father may be allocated this task in favor of the Mother if a biasing factor over-rides the contribution policy of the fairness assessment.

In order to support automated calendar negotiation, features of the calendar system may require awareness of to the difficulty level to transfer the responsibility from the assigned responsible person to the other persons sharing the responsibility. It may not always be feasible to grant access to the calendar of all responsible parties e.g. due to privacy reasons. Therefore in an example embodiment, the event description may contain state variables (reschedulability parameters) maintaining information about the difficulty level of transferring the responsibility of the event to other participants. For example, if one of the responsible persons would be working for a military contractor, contents of the work related calendar may be secret and therefore granting the visibility of calendar events to other parties from the calendar application may not be possible. Therefore in many cases it may be sufficient to maintain the state information of the difficulty level for reassigning the event to other responsible parties. By maintaining the state information it may not be necessary to refer to an individual person and consequently, privacy of an individual responsible person may be secured more easily. With these reschedulability parameters, automatic and semiautomatic scheduling functions may estimate how likely it is that the person would be assigned to a certain task. Therefore, allocation of time events or resources with high likelihood for future allocation could be avoided by leaving the potential option for schedulability open until it is necessary to utilize the available time. This type of prediction of persons or resources future availability can lower the likelihood for manual negotiation 308 in FIG. 3.

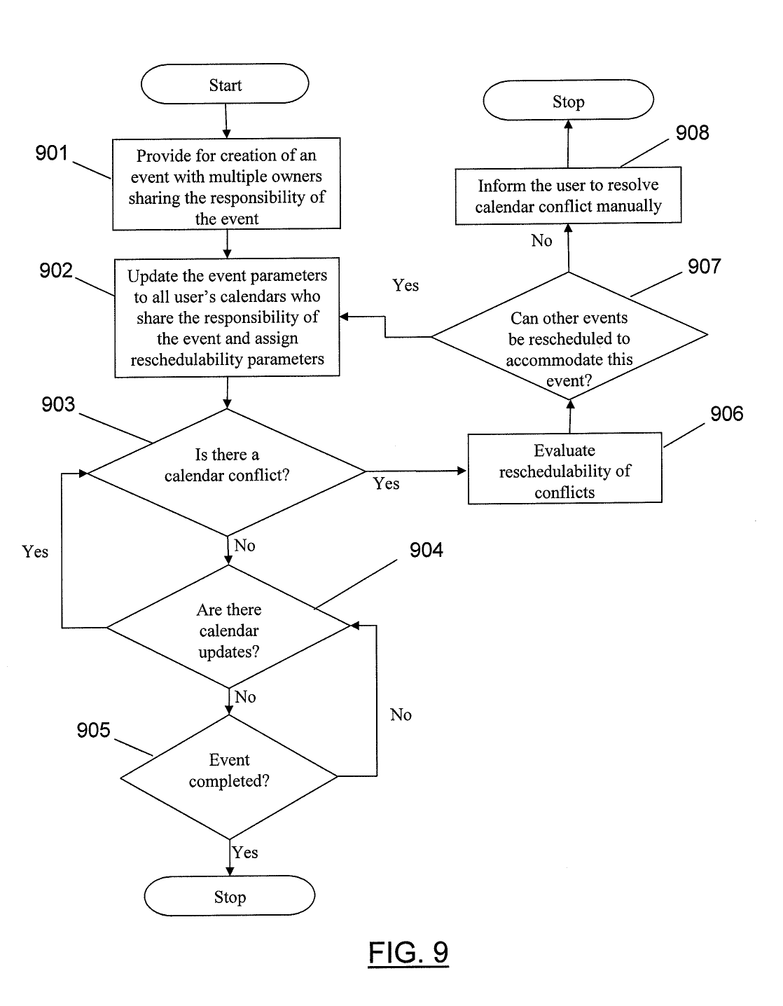

An example embodiment of a method including reschedulability parameters is illustrated in the flowchart of FIG. 9. An event is created at 901 with multiple owners sharing the responsibility. The event parameters are updated for all of the user's calendar who are the responsibility of the event and reschedulability parameters are determined at block 902. At block 903, the responsible user's calendars are evaluated for conflicts at 903. If there is a conflict, the reschedulability of the event is evaluated with respect to the reschedulability of the conflicting events at 906. At 907, it is determined whether or not events with a lower difficulty of reschedulability can be rescheduled to accommodate the new event, and if so, the calendars of all responsible users are updated accordingly and reviewed for conflicts at 902 and 903. If other events cannot be rescheduled in order to accommodate the new event, the event may need to be manually rescheduled at 908. If there are no conflicts at block 903, the event is updated on the user's calendars and the method proceeds according to the steps illustrated in the flowchart of FIG. 3.

Example embodiments of the present invention may use both the reschedulability parameters and the fairness criteria together in a single system that uses the reschedulability for assessment of the difficulty to transfer an event from one responsible party to another, while using the fairness assessment to influence the decision to transfer the event. Such an embodiment may employ a control architecture such as the Kalman filter state-space control system. In such an embodiment, the reschedulability may have the role of the prediction (state transition) matrix and fairness may have the role of measurement (update) error. This control system may be employed, for example, at operation 907 of FIG. 9.

As described above, FIGS. 3, 4, and 9 are flowcharts of a system, method and program product according to some example embodiments of the present invention. It will be understood that each block or operation of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, the computer program instructions which embody the procedures described above may be stored by a memory device of a mobile terminal or other apparatus (e.g., apparatus 50) employing embodiments of the present invention and executed by a processor (e.g., processor 70) in the mobile terminal or other apparatus. As will be appreciated, any such computer program instructions may be loaded onto a computer or other programmable apparatus (e.g., hardware) to produce a machine, such that the instructions which execute on the computer (e.g., via a processor) or other programmable apparatus implement the functions specified in the flowchart block(s) or operation(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instructions which implement the function specified in the flowchart block(s) or operation(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s) or operation(s).

Accordingly, blocks or operations of the flowcharts support combinations of means for performing the specified functions, combinations of operations for performing the specified functions and program instruction means for performing the specified functions. It will also be understood that one or more blocks or operations of the flowcharts, and combinations of blocks or operations in the flowcharts, can be implemented by special purpose hardware-based computer systems which perform the specified functions or operations, or combinations of special purpose hardware and computer instructions.

In an exemplary embodiment, an apparatus for performing the method of FIGS. 3 and/or 4 may comprise a processor (e.g., the processor 70) configured to perform some or each of the operations (301-308, 401-409, and/or 901-909) described above. The processor may, for example, be configured to perform the operations (301-308, 401-409, and/or 901-909) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 301-308, 401-409, and/or 901-909 may comprise, for example, the processor 70 and/or an algorithm executed by the processor for implementing the calendar application described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
providing for creation of a calendar event with a plurality of responsible parties;
assigning the calendar event to a subset of the plurality of responsible parties;
updating the calendars of each of the subset of the plurality of responsible parties with the calendar event;
determining if a conflict exists with respect to the calendar event for any of the subset of the plurality of responsible parties; and
resolving the conflict by reassigning the calendar event to a second subset of the plurality of responsible parties in response to determining that a conflict exists.

2. A method according to claim 1, wherein the plurality of responsible parties includes at least two people, and the subset of the plurality of responsible parties and the second subset of the plurality of responsible parties each include at least one person.

3. A method according to claim 1, wherein assigning the calendar event to a subset of the plurality of responsible parties comprises assessing the fairness of the assignment.

4. A method according to claim 3, wherein the assessing the fairness of the assignment comprises applying rules associated with a contribution policy to calendar events previously completed by the subset of the plurality of responsible parties and future calendar events assigned to the subset of the plurality of responsible parties.

5. A method according to claim 1, wherein assigning the calendar event to a subset of the plurality of responsible parties includes assigning a reschedulability parameter to reflect the difficulty required to reschedule the event and wherein resolving the conflict includes evaluating the reschedulability parameter of the calendar event and a reschedulability parameter of a conflicting event.

6. A method according to claim 1, wherein providing for creation of a calendar event includes providing for creation of rules associated with the calendar event and wherein the assigning of the calendar event to a subset of the plurality of responsible parties includes evaluating the plurality of responsible parties with respect to the rules associated with the calendar event.

7. A method according to claim 6, further comprising updating the calendars of the responsible parties that are not included in the subset of the plurality of responsible parties with the calendar event.

8. A method according to claim 1, further comprising:
assessing future calendar events assigned to the subset of the plurality of responsible parties; and
reassigning the future calendar events of the subset of the plurality of responsible parties.

9. An apparatus comprising at least one processor and at least one memory including computer program code, the at least one memory and the computer program code configured to, with the at least one processor, cause the apparatus to:
provide for creation of a calendar event with a plurality of responsible parties;
assign the calendar event to a subset of the plurality of responsible parties;
update the calendars of each of the subset of the plurality of responsible parties with the calendar event;
determine if a conflict exists with respect to the calendar event for any of the subset of the plurality of responsible parties; and
resolve the conflict by reassigning the calendar event to a second subset of the plurality of responsible parties in response to determining that a conflict exists.

10. An apparatus according to claim 9, wherein the plurality of responsible parties includes at least two people, and the subset of the plurality of responsible parties and the second subset of the plurality of responsible parties each include at least one person.

11. An apparatus according to claim 9, wherein assigning the calendar event to a subset of the plurality of responsible parties comprises assessing the fairness of the assignment.

12. An apparatus according to claim 11, wherein the assessing the fairness of the assignment comprises applying rules associated with a contribution policy to calendar events previously completed by the subset of the plurality of responsible parties and future calendar events assigned to the subset of the plurality of responsible parties.

13. An apparatus according to claim 9, assigning the calendar event to a subset of the plurality of responsible parties includes assigning a reschedulability parameter to reflect the difficulty required to reschedule the event and wherein resolving the conflict includes evaluating the reschedulability parameter of the calendar event and a reschedulability parameter of a conflicting event.

14. An apparatus according to claim 9, wherein providing for creation of a calendar event includes providing for creation of rules associated with the calendar event and wherein the assigning of the calendar event to a subset of the plurality of responsible parties includes evaluating the plurality of responsible parties with respect to the rules associated with the calendar even.

15. An apparatus according to claim 14, further comprising computer program code configured to, with the at least one processor, cause the apparatus to update the calendars of the responsible parties that are not included on the subset of the plurality of responsible parties with the calendar event.

16. An apparatus according to claim 9, wherein the at least one memory and the computer program code are configured to, with the at least one processor, cause the apparatus to:
assess future calendar events assigned to the subset of the plurality of responsible parties; and
reassign the future calendar events of the subset of the plurality of responsible parties.

17. A computer program product comprising at least one computer-readable storage medium having computer-executable program code instructions stored therein, the computer-executable program code instructions comprising:
program code instructions for providing for creation of a calendar event with a plurality of responsible parties;
program code instructions for assigning the calendar event to a subset of the plurality of responsible parties;
program code instructions for updating the calendars of each of the subset of the plurality of responsible parties with the calendar event;
program code instructions for determining if a conflict exists with respect to the calendar event for any of the subset of the plurality of responsible parties; and
program code instructions for resolving the conflict by reassigning the calendar event to a second subset of the plurality of responsible parties in response to determining that a conflict exists.

18. A computer program product according to claim 17, wherein the program code instructions for assigning the calendar event to a subset of the plurality of responsible parties comprises program code instructions for assessing the fairness of the assignment, wherein the program code instructions for assessing the fairness of the assignment comprise program code instructions for applying rules associated with a contribution policy to calendar events previously completed by the subset of the plurality of responsible parties and future calendar events assigned to the subset of the plurality of responsible parties.

19. A computer program product according to claim 17, wherein the program code instructions for assigning the calendar event to a subset of the plurality of responsible parties includes program code instructions for assigning a reschedulability parameter to reflect the difficulty required to reschedule the event and wherein the program code instructions for resolving the conflict includes program code instructions for evaluating the reschedulability parameter of the calendar event and a reschedulability parameter of a conflicting event.

20. A computer program product according to claim 17, the computer-executable program code instructions further comprising:
program code instructions for assessing future calendar events assigned to the subset of the plurality of responsible parties; and
program code instructions for reassigning the future calendar events of the subset of the plurality of responsible parties.
